(19) United States
(12) Patent Application Publication
(10) Pub. No.: US 2004/0083227 A1
(43) Pub. Date: Apr. 29, 2004

(54) Implementation of a memory efficient matrix

(76) Inventor: Darrell F. Yocom, Lakewood, CA (US)

Correspondence Address: PATENT COUNSEL, TRW INC., S & E LAW DEPT., ONE SPACE PARK, BLDG. E2/6051, REDONDO BEACH, CA, 90278, US

(21) Appl. No.: 10/280,457

(22) Filed: Oct. 24, 2002

(51) Int. Cl. G06F 7/00

(52) U.S. Cl. 707/101

(57) ABSTRACT

Instructions are provided for creating a memory efficient matrix (8) within a memory source (4). The memory efficient matrix (8) includes a plurality of map containers (10) stored within array cells (12) of an array (13). The map containers (10) include a plurality of map container cells (14), each of which contains a key value (16) and a data value (17). If a map container (10) does not contain any data, a default value such a null cell or null value is returned upon query. The memory efficient matrix (8) can be read and written to by specifying a row value and a column value. The column value is treated as a key value (16) and the row value identifies a particular map container (10) by virtue of the array cells (12) of the array (10).

### FIELD OF THE INVENTION

The present invention relates to data storage and retrieval software applications and, more particularly, to a software application for creating more efficient storage and retrieval of data.

### BACKGROUND OF THE INVENTION

Conventional software applications utilize two-dimensional matrices or arrays created in a computer memory. A typical two-dimensional matrix has n rows and m columns. The amount of memory blocks required to be allocated for creating the two-dimensional matrix is proportional to n*m, where n and m are positive integers greater than or equal to one.

However, in many software applications these matrices are not fully populated with data and are therefore referred to as sparse matrices or sparse arrays. A large portion of the memory allocated for a typical sparse matrix is wasted memory that could otherwise be used by other software applications. In addition, if a sparse matrix is very large (if n and m are very large numbers), the amount of memory required for properly allocating the matrix may exceed the available memory capacity or degrade overall system performance by virtue of the matrix size and time required to traverse the matrix. These problems are further exacerbated when the sparse matrix has more than two dimensions.

Accordingly, an object of the present invention is to provide a computer program for creating a matrix within a memory source that utilizes the memory source in a more efficient manner by substantially limiting the size of the matrix to only a size sufficient to store populated data.

It is a further object of the present invention to provide a computer program that is capable of quickly traversing efficient matrices created thereby.

It is a further object of the present invention to provide a computer program that generates efficient matrices that are compatible with conventional matrices.

### BRIEF SUMMARY OF THE INVENTION

Accordingly, the present invention provides a computer program and methodology for creating a memory efficient array, or matrix, in a memory source. The memory efficient matrix includes a row or column array as a first dimension and a plurality of map container cells as additional dimensions. The row or column array includes a plurality of array cells for storing a plurality of map containers. Each of the plurality of map containers includes a map container iterator and the plurality of map container cells. Each of the plurality of map container cells includes a data value and a key value. The key value for each of the plurality of map container cells is used for providing indexing of the plurality of map container cells.

The memory efficient matrix can be implemented to have more than two dimensions by storing pointers as the data values in the plurality of map container cells. Each of the pointers points to a memory location in which either another row or column array or another map container is stored.

The present invention further provides instructions for traversing the memory efficient array by utilizing the map container iterator and a memory efficient matrix iterator.

The present invention further provides portability between the memory efficient matrix and conventional matrices by returning a null value if a non-existent map container cell is specified by a user during an attempt to retrieve data, and by creating a new map container cell if the non-existent map container cell is specified during an attempt to store data.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram of an exemplary environment in which the present invention is implemented.

FIG. 2 is a block diagram of an exemplary memory efficient matrix and general parameters stored in a memory source.

FIG. 3 is a block diagram of an exemplary implementation of a map container.

FIG. 4 is a diagram of a conventional sparse matrix.

FIG. 5 is a block diagram of an exemplary memory efficient matrix further showing the map container cells.

FIG. 6 is an exemplary flow diagram of a preferred methodology for creating a memory efficient matrix and defining the general parameters.

FIG. 7 is an exemplary flow diagram of a preferred methodology for returning a value of a map container cell in the memory efficient matrix.

FIG. 8 is an exemplary flow diagram of a preferred methodology for returning a reference to a map container cell in order to permit modification of the map container cell.

FIG. 9 is an exemplary flow diagram of a preferred methodology for clearing all of the data values of the plurality of map container cells in the plurality of map containers.

FIG. 10 is an exemplary flow diagram of a preferred methodology for determining if the memory efficient matrix is not populated (empty).

FIG. 11 is an exemplary flow diagram of a preferred methodology for erasing a particular map container cell.

FIG. 12 is an exemplary flow diagram of a preferred methodology for determining if a particular map container cell of the memory efficient matrix exists.

FIG. 13 is an exemplary flow diagram of a preferred methodology of traversing the memory efficient matrix for locating the first populated map container cell.

FIG. 14 is a block diagram showing how pointers in a map container cell communicate with other map containers and provide the memory efficient matrix with multiple dimensions.

FIG. 15A-15B are block diagrams of alternative implementations of the memory efficient matrix.

FIG. 16 is a block diagram of a further alternate implementation of the memory efficient matrix.

### DETAILED DESCRIPTION OF THE INVENTION

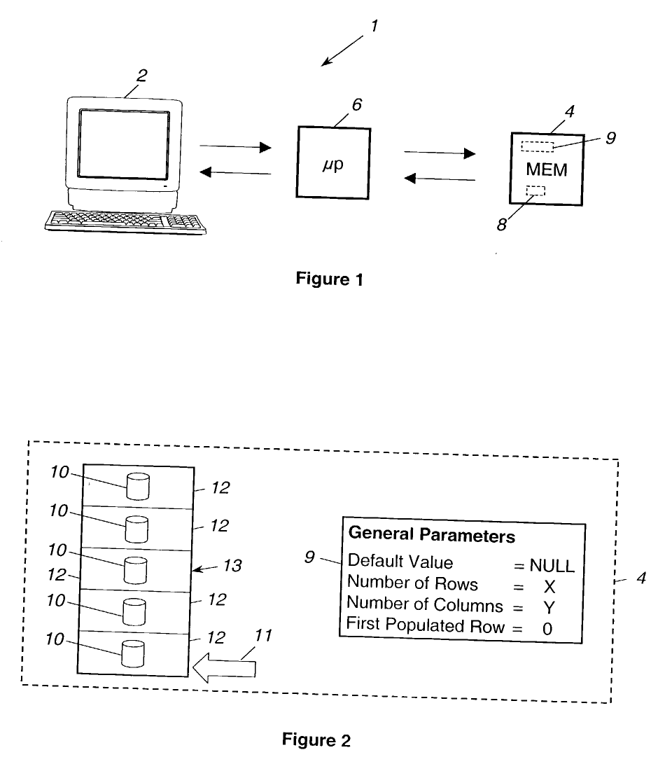

Referring now to the drawings in which like numerals reference like parts, FIG. 1 shows an exemplary computer operating environment 1 in which a user (not shown) utilizes an input device 2, such as a Windows platform based personal computer, to store data in a memory source 4 via an appropriate computer program or software application. The user may be another software application such as, for example, a middleware software application, or a person manually controlling the input device 2. The data may be, for example, computer modeling data, geosynchronous tracking coordinates of objects that are orbiting the Earth, real time system data such as customer purchase tracking data, or any other type of data that is typically stored and represented in matrix format. A microprocessor or microcomputer (processor) 6 controls the operation of storing and retrieving the data in the memory source 4.

Referring to FIGS. 1 and 2, the methodology by which the processor 6 stores and retrieves data is determined by a software application or computer program according to the present invention that is written in a high-level language such as, for example, C++ or Java, and that is loaded into the memory source 4 via, for example, the input device 2 and compiled by a compiler (not shown). The compiler translates the computer program into a low-level machine code that is readable by the processor 6. In a preferred embodiment of the present invention, and as will be more fully discussed below, the computer program commands the processor 6 to create a memory efficient matrix 8 in the memory source 4 and to store the data in the memory efficient matrix 8. The computer program further commands the processor 6 to store general parameters 9 associated with the memory efficient matrix 8 in the memory source 4.

Referring to FIG. 2, the memory efficient matrix 8 is formed by storage structures that will be referred to as map containers 10. The memory efficient matrix 8 may include, for example, a memory efficient matrix iterator 11 for pointing to one of the map containers 10. Each of the map containers 10 is stored in one of a plurality of array cells 12 of an array of rows (array) 13. As will be appreciated by those skilled in the art, in the exemplary computer operating environment 1, a user (such as a middleware program) selects individual ones of the array cells 12 by specifying a particular array cell 12 by its column number, which is used as an array index. The general parameters 9 associated with the memory efficient matrix 8 include, for example, a default value for map container cells (discussed below) of the map containers 10, the total number of rows and columns defined, and an iterator or pointer that points to or has a value in accordance with the first row (map container 10) with data therein (a populated map container cell).

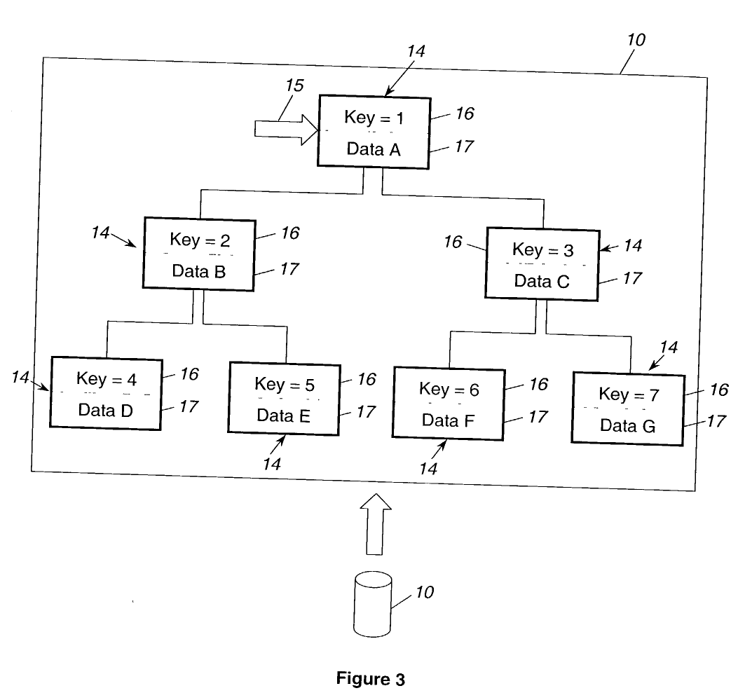

Referring to FIG. 3, each of the map containers 10, which may be, for example, a map template from a C++ standard template library, includes a plurality of map container cells 14. Each of the map containers 10 may also include a map container iterator 15, which may be an iterator included with the map template. Each of the map container cells 14 contains at least a key value 16 and a data value 17. The key value 16 and data value 17 may be, for example, a pair template from the C++ standard template library. Specifying a key value 16 for one of the map container cells 14 enables the map container cell 14 to be selected. As shown, the map container 10 may include the plurality of map container cells 14 in a binary tree configuration. As will be appreciated by those skilled in the art, the binary tree configuration provides a search time of log₂(n), in which n refers to the total number of the map container cells 14. The memory efficient matrix 8 will have a traversal time of r+pc, in which r refers to the total number of rows (or map containers) and pc refers to the total number of populated map container cells.

Referring to FIG. 4, an exemplary conventional sparse matrix 18 is shown having four rows and four columns. Therefore, approximately sixteen blocks of memory will be allocated for this sparse matrix. However, as shown, only eight of the blocks actually contain data. Therefore, eight blocks of the memory source 4 (FIG. 1) allocated for this sparse matrix 18 are wasted. Also, the configuration of this sparse matrix 18 has a traversal time of n*m, in which n refers to a total number of matrix columns (four in this example), and m refers to a total number of matrix rows (four in this example). For this example, sixteen matrix cells must be visited to traverse the sparse matrix 18.

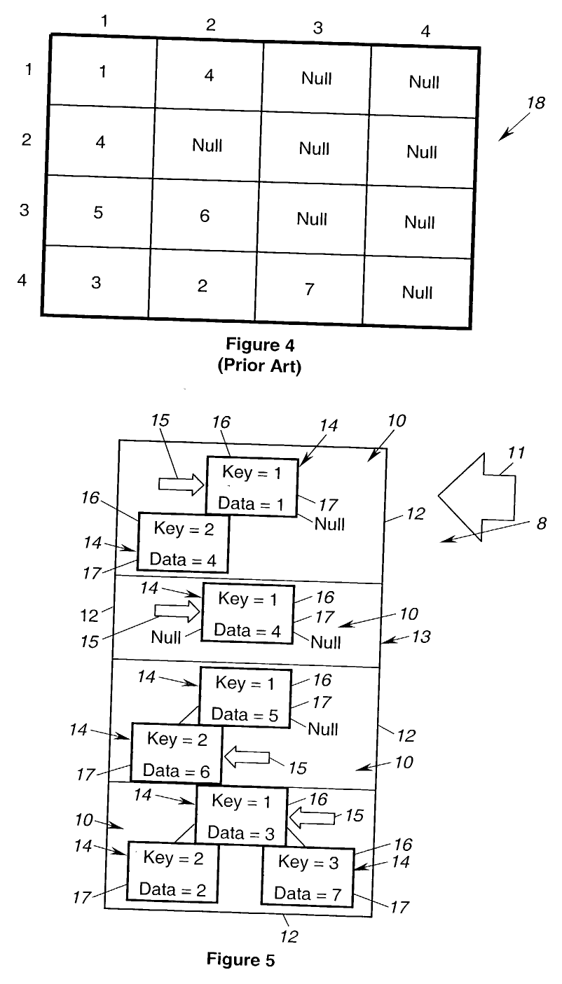

Referring to FIG. 5, the same data contained in the conventional sparse matrix 18 in FIG. 4 is stored in a memory efficient matrix 8. The memory efficient matrix 8 includes an array 13 having four rows or array cells 12. Map containers 10 are stored within the respective array cells 12. Each of the map containers 10 stores data in its respective map container cell or cells 14 that would be stored in a respective row of the conventional sparse matrix 18 (FIG. 4). In the present example, only eight blocks of memory are required to be allocated for implementing the memory efficient matrix 8. Also, through utilization of the key values 16 as column indices, individual map container cells 14 can be accessed in a manner similar to the conventional sparse matrix 18. For example, specifying row one and column one for the conventional sparse matrix 18 returns a data value of one. Specifying row one and column one for the memory efficient matrix 8 will also return a data value of one. This is because the column index value specified is used as a key value 16 in the specified row.

If a non-existent map container cell is specified during an attempt to retrieve data, (referred to as a read operation), a null value (or other default value) is returned. If a non-existent map container cell is specified during an attempt to store data (referred to as a write operation), a new map container cell is dynamically created at the specified coordinate. The returning of a null value during a read operation and the creation of a new map container cell 14 during a write operation provides portability between the memory efficient matrix 8 and normal matrices. In other words, other software applications that involve matrix manipulation will be able to manipulate the memory efficient matrix 8 in a manner similar to the conventional sparse matrix 18.

The exemplary matrices in FIGS. 4-5 are respectively a sparse matrix with only sixteen elements and eight data cells and a memory efficient matrix 8 with only eight map container cells 14 and are for discussion purposes and ease of illustration only. However, a memory efficient matrix may prove to be even more beneficial when a large memory efficient matrix such as, for example, a matrix with hundreds or thousands of map container cells, is required for a particular application. For example, a conventional sparse matrix with one hundred rows and one hundred columns but containing only 200 data values requires an allocation of ten thousand memory blocks and has a traversal time of n=10,000(n=100*100) when searching for populated cells. In comparison, a memory efficient matrix for storing the same amount of data has a traversal time of approximately three hundred (n=100 rows+200 populated cells).

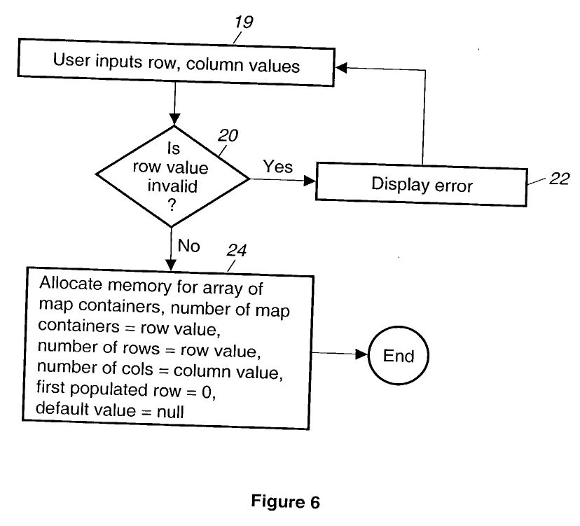

Referring to FIGS. 6-15, methodologies for implementing and utilizing the memory efficient matrix 8 will now be discussed in view of the elements illustrated in FIGS. 2-3 and 5.

FIG. 6 illustrates a methodology (map container instructions) for creating the map containers 10 that each include multiple map container cells 14, and wherein each of the map container cells 14 contains a key value 16 and data value 17. Together, these components create the array 13 that includes the array cells 12 for storing the map containers 10 and thus create the memory efficient matrix 8. At 19 a user inputs (enters) matrix parameters into the input device 2 that are read into the memory source 4. The matrix parameters are, for example, a row and a column value. Even though the user enters a column value, this column value is not used for allocating memory for the memory efficient matrix 8. However, this column value is stored in the general parameters 9 for providing warnings to the user (discussed later). The row value is also stored in the general parameters 9 as the total number of rows.

At 20, it is determined whether the row value entered by the user is invalid or, in other words, outside of a boundary value. An example of an invalid row value would be a negative number. If it is determined that the row value entered is outside of the boundary value, then at 22 an error message is displayed to the user along with a command to enter a valid row value.

After determining that the row value entered is valid, at 24 a one-dimensional array 13 that has a number of array cells 12 corresponding to the row value is allocated (array instructions). A number of map containers 10 corresponding also to the row value are created and are respectively stored in the array cells 12 of the array 13. A default value such as, for example, null, is stored in the general parameters 9. However, the user may also specify a nonnull default value such as, for example, negative one as an input parameter. An iterator (not shown) which will be referred to as Begin Row is initialized to point to the first map container with the first populated map container cell 14 or to zero if there are no populated map container cells.

The plurality of map containers 10 may be created by, for example, utilizing the map template data structure provided in the C++ standard template library and may be implemented by, for example, a constructor (not shown). The map container instructions may further include instructions for creating the map container iterator 15 in each of the plurality of map containers 10 for traversing the map container cells 14. The map container iterator 15 can be created by, for example, utilizing the map template data structure from the C++ standard template library.

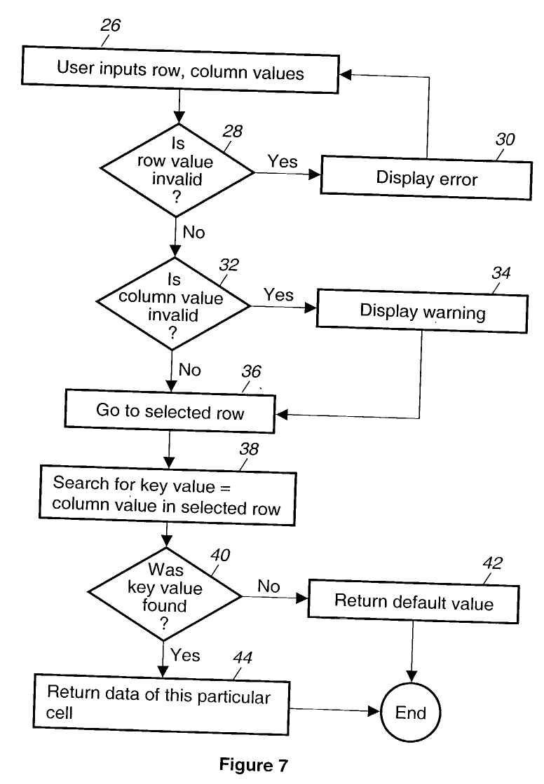

Referring to FIG. 7, a methodology for retrieving data from the memory efficient matrix 8 by selectively specifying the array cells 12 based on an array index and the map container cells 14 of a map container 10 stored within the array cells 12 based on respective key values 16 (retrieve instructions) will be discussed. At 26, a user enters parameters for the memory efficient matrix 8. The parameters include a row and column value of a map container cell 14 for which the user wishes to retrieve the data value that is stored in the memory efficient matrix 8. At 28, it is determined whether the row value entered by the user is valid. If it is determined that the row value entered is invalid, then at 30 an error message is displayed to the user along with a command to enter a valid row value.

After determining that the row value entered is valid, at 32 it is determined whether the column value entered by the user is valid by using, for example, the number of columns specified by the user upon creation of the matrix which is stored in the general parameters 9. If it is determined that the column value entered is invalid, then at 34 a warning message is displayed to the user. Because the column value is used solely for finding the key value 16, an invalid column value is not a critical error. The user, or calling program, must decide, upon receiving the warning 34, the severity of an invalid column number. However, the retrieve instructions will work correctly for any integer column number regardless of its validity as a column value.

Next, at 36 the selected row (or array cell 12) is located by the row value (array index). One of the map containers 10 is stored in this array cell 12. At 38, the key value 16 that is equal to the column value entered by the user is searched by, for example, traversing through map container cells 14 of the map container 10 by the map container iterator 15 or other conventional cell traversing methods. This can be done by, for example, utilizing a Find iterator included within the map template data structure of the C++ standard template library. The Find iterator efficiently locates the desired map container cell by searching the binary tree implementation of the map container 10. Next, at 40 a decision is made as to whether the key value 16 was found. This can be done by, for example, determining if the Find iterator is pointing to a not-found value such as End or if it points to a valid key value 16. If the iterator is pointing to the End value, then no such map container cell was found, and at 42 the default value is returned to the user. Therefore, if a non-existent map container cell is specified during an attempt to retrieve a data value, this default value, such as null, is returned. As mentioned with respect to the map container instructions, the user was given the option of setting a default value to be returned during attempts to retrieve data from non-existent map container cells.

If the Find iterator is pointing to a valid key value 16 or another traversing method has reached the key value 16, then at 44 the data value 17 of the map container cell 14 having this key value 16 is returned to the user.

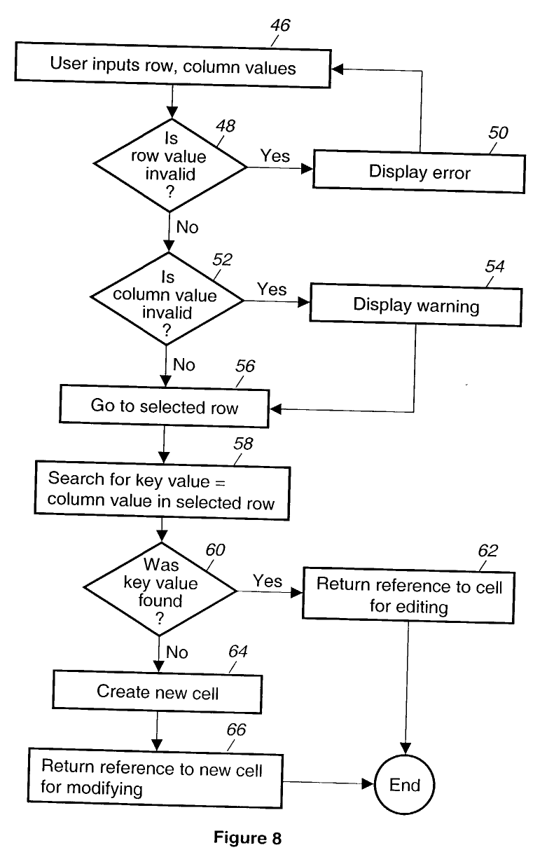

Referring to FIG. 8, a methodology for storing data in the memory efficient matrix 8 by selectively specifying one of the array cells 12 based on an array index and the map container cells 14 of the map container 10 stored within the one of the plurality of array cells 12 based on respective key values (store instructions) will be discussed. At 46, a user enters parameters for the memory efficient matrix 8. The parameters include a row and column value identifying the map container cell in which the user wishes to store the data. At 48, it is determined whether the row value entered by the user is valid. If it is determined that the row value entered is invalid, than at 50 the error message is displayed to the user along with a command to enter a valid row value. After determining that the row value entered is valid, at 52 it is determined whether the column value entered by the user is valid. If it is determined that the column value entered is invalid, than at 54 the warning message is displayed to the user. As discussed with respect to the retrieval instructions, an invalid column number is not a critical error. The user, or calling program, must decide upon receiving the warning 34, the severity of an invalid column number. However, the store instructions will work correctly for any integer column number regardless of its validity as a column value.

Next, at 56 the selected row or array cell 12 is located by the row value (array index). One of the map containers 10 is stored in this array cell 12. At 58, the key value 16 that is equal to the column value entered by the user is searched as discussed above in the retrieve instructions shown in FIG. 7. Next, at 60 a decision is made as to whether the key value 16 was successfully found also as discussed above with respect to the retrieve instructions. If the key value 16 was successfully found, at 62 the store instructions return a reference to this particular map container cell 14 of this key value 16 to the user for overwriting, and the store instructions end.

If the key value 16 was not successfully found (the map container iterator 15 is pointing to or, the traversal method has reached, the end value), then at 64 a new map container cell 14 is created within the map container 10. This new map container cell 14 may be created by, for example, well-known dynamic allocation procedures. The key value 16 for this new map container cell 14 is set to the column value entered by the user. As an aid to future iteration, if the row number thus populated has a value (row number) less than the Begin Row parameter stored in the general parameters 9, the value of the Begin Row is set to the row number of the map container cell being populated.

At 66, a reference to this new cell is returned for overwriting and the store instructions end. Therefore, if a non-existent map container cell is specified during an attempt to store a data value, a new map container cell 14 is created for storing the data.

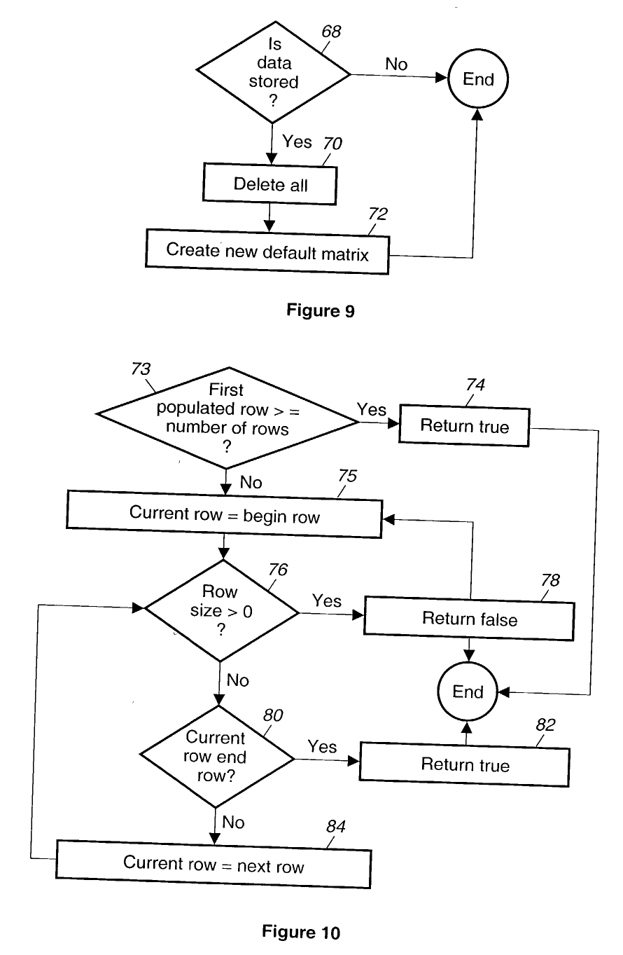

Referring to FIG. 9, a methodology for clearing all of the data values (clear instructions) in the map container cells 14 will be discussed. At 68, it is determined whether data values are present within any of the map containers 10. This is done by traversing through each of the plurality of map containers 10 and determining if any of them contain any data. This traversing can be quickly performed because, if a map container 10 is empty, the End value will be the first and only value iterated. If none of the map containers 10 store any data values, the clear instructions end. This determination of whether any data values are present can also be done by using the isEmpty instructions discussed below.

If any of the map containers 10 contain any data other than the end value, at 70 all the map container cells 14 of each map container 10 are deleted by, for example, deleting all items stored in a heap memory (not shown). As will be appreciated by those skilled in the art, dynamically created elements are stored in heap memory. The heap memory can be deleted by one command. At 72, a new memory efficient matrix 8 is created using the same row and column values of the cleared memory efficient matrix 8, and the clear instructions end.

Referring to FIG. 10, a methodology for determining whether the memory efficient matrix 8 is empty (isEmpty instructions) will be discussed. At 73, it is determined if the begin row value (first populated row) stored in the general parameters 9 is equal to or is greater than the total number of rows which is also stored in the general parameters 9. If the begin row value is greater than or equal to the total number of rows, then the memory efficient matrix 8 is determined to be empty and at 74 the isEmpty instructions return the Boolean value of TRUE and subsequently end. If the begin row value is less than the total number of rows, at 75, the memory efficient matrix iterator 11 that will be referred to as current row 11 is set to point to or have a value in accordance with the Begin Row value stored in the general parameters 9. At 76, it is determined if the size of the row to which current row currently points (the number of map container cells 14) is greater than zero. If the size of this row is greater than zero, then at 78 the isEmpty instructions return the Boolean value FALSE and subsequently end.

At 80, it is determined if the current row 11 is pointing to the End row. For example, if there are four rows and the current row has a value of four (three if the first row has a value of zero), then the current row is the end row. If the current row 11 is pointing to the end row, then at 82 the isEmpty instructions return the Boolean value TRUE and subsequently the methodology ends. If the current row 11 is not pointing to the last row, at 84 current row 11 is incremented to point to or have a value in accordance with a next row. The isEmpty instructions then loop to 76 and continue until an exit condition is satisfied.

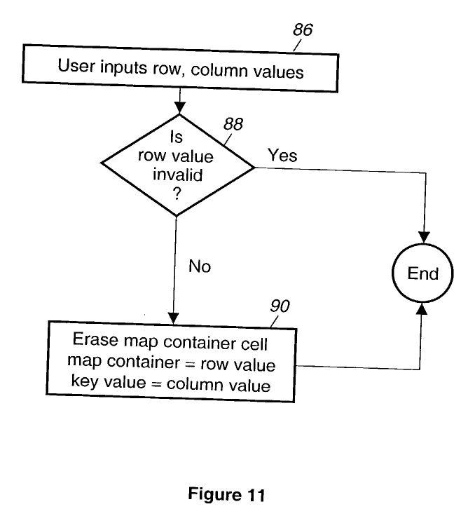

Referring to FIG. 11, a methodology for deleting the data value in a specified map container cell 14 (delete instructions) will be discussed. At 86, a user enters parameters for the memory efficient matrix 8. The parameters should include a row and column value for which the user wishes to delete a data value. At 88, it is determined whether the row value entered by the user is valid. If it is determined that the row value entered is invalid, the delete instructions end.

At 90, the specified map container cell 14 is located by using the row value for specifying the map container 10 and the column value as the key value 16 and is then removed. This specified map container cell 14 could be removed by, for example, utilizing an erase function included with the map from the C++ standard template library. The delete instructions subsequently end. If, at 90, the column number is never found then the process ends without any deletions.

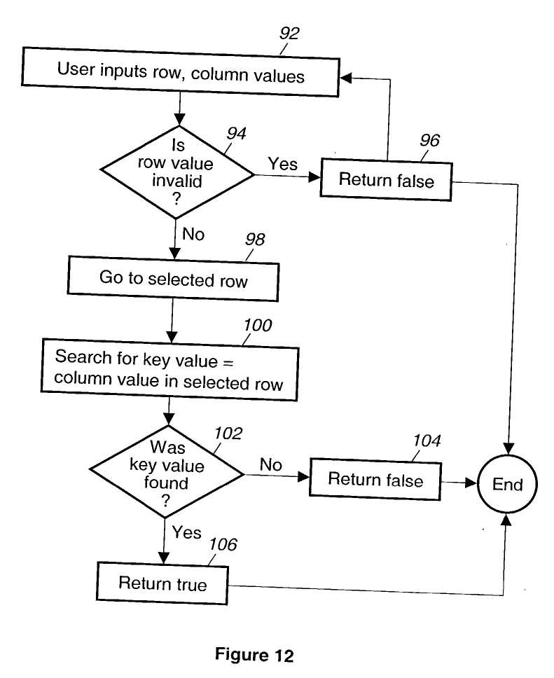

Referring to FIG. 12, a methodology for determining if a particular map container cell 14 exists (existence instructions) will be discussed. At 92, a user enters parameters, such as a row and column value, for a map container cell 14 to determine if the map container cell 14 exists. At 94, it is determined whether the row value entered by the user is valid. If it is determined that the row value entered is invalid, at 96 the existence instructions return a Boolean value of FALSE and subsequently end. If it is determined that the entered row value is valid, at 98 the selected row or array cell 12 is located by the row value (array index).

At 100, the key value 16 that is equal to the column value entered by the user is searched as discussed above in the retrieve instructions shown in FIG. 7. Next, at 102 a decision is made as to whether the key value 16 was successfully found also as discussed above with respect to the retrieve instructions. If the key value 16 is not found, then at 104 a Boolean value of FALSE is returned and the existence instructions end. If the iterator is pointing to a key value, then at 106 a Boolean value of TRUE is returned and the existence instructions end.

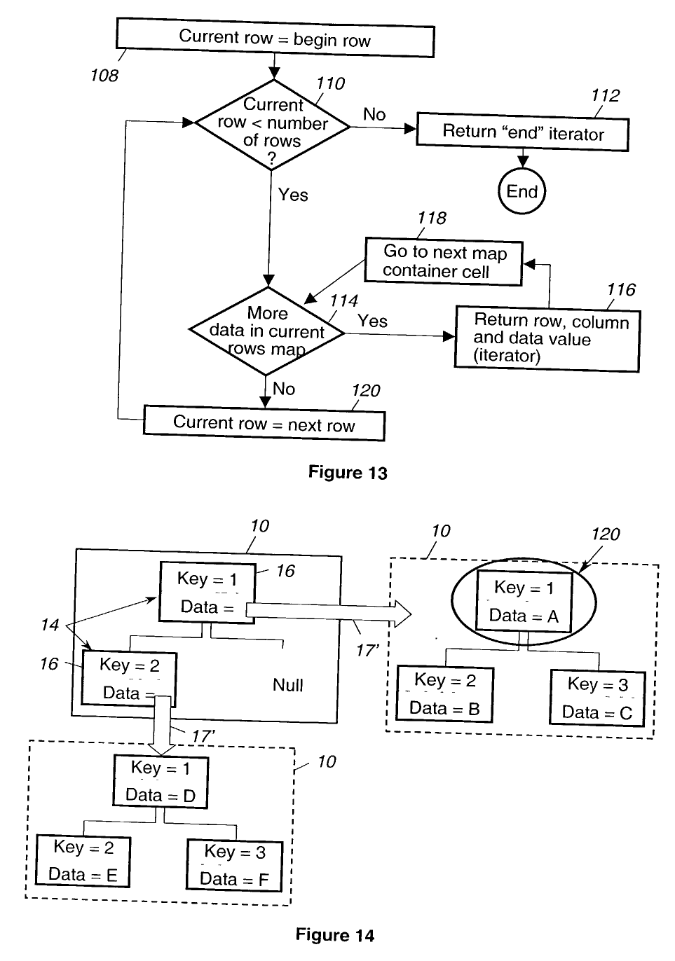

Referring to FIG. 13, a methodology for traversing the memory efficient matrix (traversal instructions) to return only populated cells will be discussed. At 108, the memory efficient matrix iterator (current row) 11 is initialized to point to the first row (or first map container 10). At 110 it is determined whether the row to which the current row 11 points has a row value (or row index) that is less than the total number of rows (or map containers 10) in the memory efficient matrix 8. This can be done by, for example, comparing the value of current row 11 with the value of end row stored in the general parameters 9. If the value of current row 11 is equal to or greater than the total number of rows, then at 112, an iterator value of End is returned, which signifies the end of the rows. If the row pointed to by the current row 11 has a value that is less than the total number of rows, at 114 it is determined whether the map container map container 10 contains any or anymore map container cells 14. The map container 10 will not contain any map container cells 14 if it does not have any data. If the map container 10 contains map container cells 14, at 116 the row value, column value (key value 16), and data value for this map container cell 14 is returned. This can be done by, for example, having current row 11 return a structure containing these values. At 118, the map container iterator 15 is incremented to the next map container cell, and the determination at 114 is again performed.

If, at 114, it is determined that the map container 10 does not contains any or anymore map container cells 14, current row 11 is incremented to point to the next row (or next map container 10). These operations of the traversal instructions continue until current row 11 is incremented past the total number of rows (see the decision at 110). Therefore, the traversal instructions provide an iterator for traversing the efficient matrix by looping through the plurality of array cells 12 (rows or map containers 10) of the array 13 based on the array index (row number) by the memory efficient matrix iterator 11 and the plurality of map container cells 14 by, for example, the map container iterator 15.

The instructions of this computer program are preferably implemented as a class in a high level language such as, for example, C++. Implementing the instructions as a class will permit a user to create a memory efficient matrix of any size or data type desired. As those skilled in the art will appreciate, implementing these instructions as a class will require the overloading of operators. Also, other high level languages including, for example, Java may be used.

Referring to FIG. 14, a modification to the memory efficient matrix 8 will be discussed. As shown in FIG. 14, some of the plurality of map container cells 14 may contain pointers 17′ as their data values. These pointers 17′ may point to other map containers 10, other memory efficient matrices (not shown) or other conventional matrices (not shown). By utilizing pointers 17′, the memory efficient matrix can be expanded to three or more dimensions. A map container cell such as cell 120 can be retrieved by specifying a first dimensional value (row value) of one, a second dimensional value (column value) of one and a third dimensional value of one. More than three dimensions can be implemented by placing pointers 17′ in the map container cells 14 of the map containers 10 that define the third dimension.

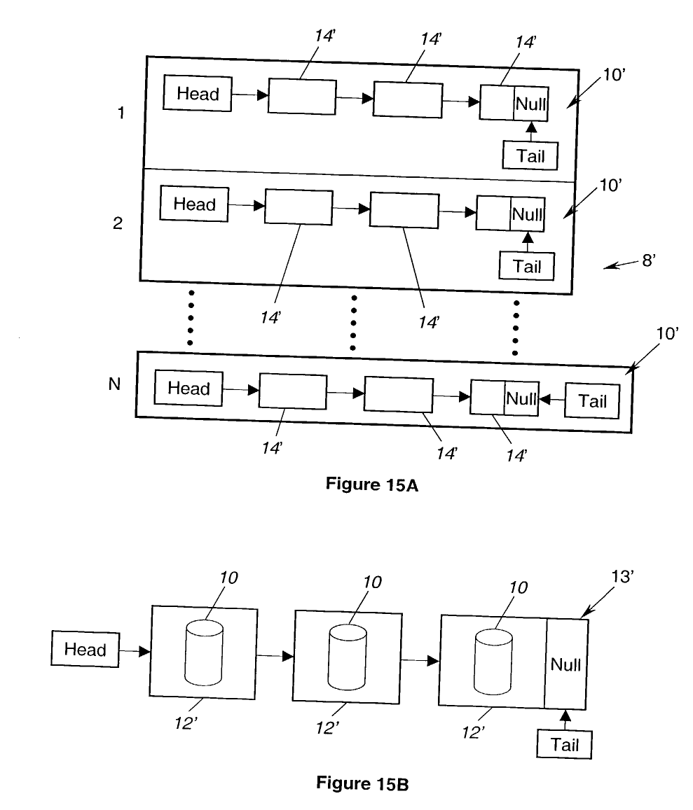

Referring to FIGS. 15A-15B, additional modifications of the present invention will be discussed. As shown previously in FIG. 2, the map container cells 14 of the map container 10 have a binary tree configuration. However, as shown in FIG. 15A, the map container cells 14′ may have a linked list configuration. In the linked list configuration, each map container 10′ will include a head pointer as well as a key value and data value (not shown) in each of the map container cells 14′. In addition to the above modification, as shown in FIG. 15B the array 13 of the memory efficient matrix 8 shown in FIG. 2 may be replaced with a linked list 13′ having a plurality of nodes 12′ rather than array cells 12.

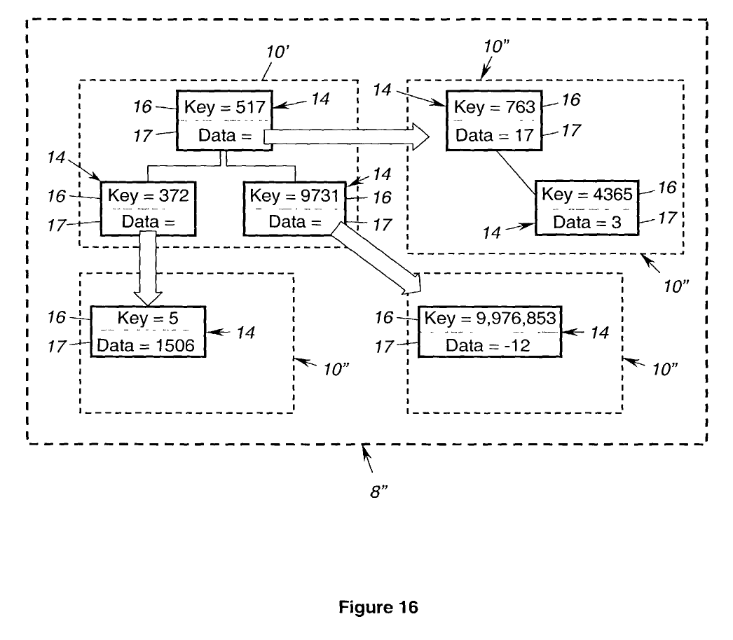

Referring to FIG. 16, another modification to the memory efficient matrix 8 will be discussed. The memory efficient matrix 8 of FIG. 2 was optimized for a moderately sparse matrix, in which many or most of the rows will contain at least one column containing data. A memory efficient matrix 8″ of FIG. 16 has been optimized for an extremely sparse matrix in which an extraordinary number of rows and columns are required and the vast majority of the rows do not contain even a single value in a column. In the memory efficient matrix 8″ of FIG. 16, the array 13 of FIGS. 2 and 5 is replaced with a primary map container 10′. The primary map container 10′ includes zero or more primary map container cells 14. The key value 17 of each of the primary map container cells 14 corresponds to the row number of the memory efficient sparse matrix 8 of FIG. 5. The data value 17 of each primary map container cell 14 is either a secondary map container such as the secondary map containers 10″ or a pointer to a secondary map container 10″. The secondary map containers 10″ are identical to map containers 10 of the memory efficient matrix 8 of FIG. 5.

In this exemplary memory efficient matrix 8″, a specific cell is accessed by specifying the key value 16 of the primary map container 10′ as the row value and the key value 16 of a secondary map container 10″ as the column value. For example, specifying a row value of 372 and a column value of five returns a value of 1506, specifying a row value of 517 and a column value of 763 returns a value of seventeen, specifying a row value of 517 and a column value of 4365 returns a value of three and specifying a row value of 9731 and a column value of 9976853 returns a value of −12. Therefore, rather than having to allocate memory blocks to account for over 9000 rows and approximately 10,000,000 columns, the memory efficient matrix 8″ implements the same data with only approximately four memory blocks. Row validity can be determined by, for example, the Find iterator of the map template and iterating through rows can be performed by a map container iterator.

An exemplary implementation of the instructions for creating the memory-efficient matrix will be discussed in which a first user populates memory with data and a second user reads it. The first user may be, for example, a “writer” software application that processes satellite observation data and the second user may be a “reader” software application that analyzes that data. In this example, an Earth observing satellite (not shown) scans an entire surface area of the Earth by dividing the Earth surface area into grid numbers and searching for a large number of predetermined objects such as, for example, military equipment such as submarines, ships, missile launchers, or tanks by satellite detection techniques. The satellite counts how many of each of the predetermined objects it finds within each grid. However, it will be unlikely that more than a few, if any, of the predetermined objects will exist within each grid.

The counts of predetermined objects within each grid will be stored in the memory efficient matrix. For example, the object type may be the row number and the grid may be the column number. The data value associated with the row/column will be the number of objects of that type detected within that grid. The data value could also be a pointer to more detailed information about the objects. As the satellite makes a detection of an object in a grid, it transmits the grid number, the object type, and the count to the writer software application. The writer software application utilizes the store instructions to store the count in the memory efficient matrix.

If a user makes a query such as, for example, “Where are all the submarines?”, the reader software application uses the integer number associated with object type “submarines” to access the row of the memory efficient matrix corresponding to submarine observations. From there, the reader software application may iterate through all submarine observations, or select the particular grid numbers (columns) of interest. For example, a user could also make a query such as “Are there any submarines in the grids adjacent to New York City?” to determine how many submarines have been detected in proximity of New York City.

The memory efficient matrix of the present invention is advantageous for the above situation and generally for situations in which an application must make an association between thousands of objects in a first set with thousands of objects in a second set, and each object in the first set is associated with a small number of objects (at least one) in the second set. This is because, for example, the size of the memory allocated for the memory efficient matrix will be substantially limited to the number of populated map container cells.

As should now be appreciated upon reading of the foregoing, the present invention provides methodologies/instructions for creating a memory efficient matrix 8. The memory efficient matrix 8 includes map containers 10. Each of the map containers 10 includes map container cells 14 and a map container iterator. The map container cells 14 are preferably provided in a binary tree configuration. The instructions are preferably provided within a C++ class utilizing the pair class and the map class and its associated iterator from the C++ standard library. A memory efficient matrix iterator is provided for traversing between map containers 10 and traversing among the map container cells 14 by utilizing the associated iterator. The binary tree configuration of the map container cells permits a search time of approximately log₂(n) within a row. Specifying null as a default value for the memory efficient matrix 8 permits portability with other matrix applications. Further, the matrix class permits a user to read and write to the memory efficient matrix 8 in the same manner in which a user would read and write to a conventional sparse matrix. Therefore, there is no need for further training to use the memory efficient matrix.

While the above description is of the preferred embodiment of the present invention, the invention may be modified, altered or varied without deviating from the scope and fair meaning of the following claims. For example, the array 13 in FIG. 2 could be a horizontal array of columns rather than a vertical array of rows.

1. A method of implementing a memory efficient matrix within a memory source comprising:
creating a plurality of map containers, each including a plurality of map container cells, wherein the plurality of map container cells include respective key values;
creating an array that includes a plurality of array cells for respectively storing the plurality of map containers and array indices; and
selectively storing data in and retrieving data from the array by selecting an array cell of the plurality of array cells based on its array index and a map container cell of a map container stored within the array cell based on its key value.

2. The method of claim 1, wherein the creating a plurality of map containers, each including a plurality of map container cells, wherein the plurality of map container cells include respective key values further comprises creating the plurality of map containers as template data structures.

3. The method of claim 1, further comprising traversing the memory efficient matrix by looping through the plurality of array cells of the array based on the respective array indices and the plurality of map container cells based on the respective key values.

4. The method of claim 3, wherein the traversing the memory efficient matrix by looping through the plurality of array cells of the array based on the respective array indices and the plurality of map container cells based on the respective key values further comprises looping through each of the plurality of array cells by using a memory efficient matrix iterator and looping through the plurality of map container cells by using a map container iterator.

5. The method of claim 1, wherein the creating a plurality of map containers, each including a plurality of map container cells, wherein the plurality of map container cells include respective key values further comprises creating the array to be one of a one-dimensional array and a multi-dimensional array.

6. The method of claim 1, wherein the creating a plurality of map containers, each including a plurality of map container cells, wherein the plurality of map container cells include respective key values further comprises creating the plurality of map containers from a C++ standard library.

7. The method of claim 1, wherein the creating a plurality of map containers that each include a plurality of map container cells further comprises creating the plurality of map containers so that each of the plurality of map container cells includes a pointer pointing to one of another of the plurality of map containers or another array for providing more than two dimensions.

8. The method of claim 1, further comprising returning a null value if a non-existent map container cell is specified during an attempt to retrieve data.

9. The method of claim 8, wherein the selectively storing data in and retrieving data from the array by selecting an array cell of the plurality of array cells based on its array index and a map container cell of a map container stored within the array cell based on its key value further comprises creating a new map container cell in one of the plurality of map containers if a non-existent cell is specified during an attempt to store data.

10. Instructions for creating a memory efficient matrix stored in a memory source comprising:
map container instructions for creating a plurality of map containers, each including a plurality of map container cells, wherein each of the plurality of map container cells contains a key value; and
array instructions for creating an array that includes a plurality of array cells for respectively storing the plurality of map containers.

11. The instructions of claim 10, further comprising:
store and retrieve instructions for selectively storing data in and retrieving data from the array by selecting an array cell from the plurality of array cells based on its array index and a map container cell from the plurality of map container cells stored within the array cell based on its key value.

12. The instructions of claim 11, wherein the map container is a template data structure from a C++ standard template library.

13. The instructions of claim 11, wherein the map container instructions are further for creating a map container iterator in each of the plurality of map containers for traversing the plurality of map container cells.

14. The instructions of claim 13, wherein each of the plurality of map containers has a binary tree configuration.

15. The instructions of claim 11, wherein the store retrieve instructions further include null instructions for returning a null value if a non-existent map container cell is specified during an attempt to retrieve data.

16. The instructions of claim 11, wherein the store and retrieve instructions further includes map container cell instructions for creating a new map container cell if a non-existing cell is specified during an attempt to store data.

17. The instructions of claim 11, wherein each of the plurality of map container cells includes a pointer pointing to one of another of the plurality of map containers or another array for providing more than two dimensions.

18. The instructions of claim 11, further including traversal instructions for traversing the memory efficient matrix by looping through the plurality of array cells of the array based on respective array indices and the plurality of map container cells based on respective key values.

19. A memory efficient matrix stored in a memory source comprising:
a plurality of map containers, each including a plurality of map container cells, wherein the plurality of map container cells include respective key values; and
a memory structure that includes an indexing means and a plurality of memory structure cells for respectively storing or pointing to the plurality of map containers,
wherein the memory structure is one of an array, a primary map container a linked list and a binary tree.

20. The memory efficient matrix of claim 19, wherein the plurality of map container cells further include respective pointers pointing to another memory efficient matrix or to another memory structure.

21. The memory efficient matrix of claim 19, wherein the plurality of map containers further include respective map container iterators for traversing the plurality of map container cells.
